(19) United States
(12) Patent Application Publication
(10) Pub. No.: US 2017/0211516 A1
(43) Pub. Date: Jul. 27, 2017

(54) ON-DEMAND OXY-HYDROGEN FUEL SYSTEM

(71) Applicant: Serge V. Monros, Santa Ana, CA (US)

(72) Inventor: Serge V. Monros, Santa Ana, CA (US)

(21) Appl. No.: 15/007,493

(22) Filed: Jan. 27, 2016

(51) Int. Cl. F02M 21/02; C25B 11/02; C25B 9/06; F02M 25/06; C25B 1/06

(52) U.S. Cl. CPC F02M 21/0287; F02M 21/0206; F02M 25/06; C25B 1/06; C25B 9/06; C25B 11/02

(57) ABSTRACT

An on-demand oxy-hydrogen fuel system for an internal combustion engine includes an oxy-hydrogen generator and a microcontroller which activates the the intake manifold. The addition of the oxy-hydrogen provides a very efficient oxy-hydrogen generator when oxy-hydrogen is needed. The oxy-hydrogen is then mixed with blow-by gases from a PCV valve which are recycled through fuel source which can dramatically increase fuel efficiency and reduce emissions.

### BACKGROUND OF THE INVENTION

The present invention generally relates to internal combustion engines. More particularly, the present invention relates to an on-demand oxy-hydrogen fuel system which is incorporated into the fuel supply system of a standard internal combustion engine.

The basic operation of conventional piston-based internal combustion engines (ICE) varies based on the functional type of combustion process, the number of cylinders and the desired use. For instance, in a traditional two-cycle engine, oil is pre-mixed with fuel and air before the oil-fuel-air mixture is injected into the cylinder where the oil/fuel/air mixture is ignited. In a typical four-cycle gasoline engine, atomized fuel is pre-mixed with air, compressed by the movement of the piston against the cylinder head, and ignited by a spark plug that causes the fuel to burn. In a diesel engine, fuel and air are pre-mixed, atomized, and injected into the cylinder. However, in a diesel engine there is no spark plug to provide ignition. Instead, the fuel/air mixture is ignited by the combination of heat accumulated by the mass of the cylinder head and compression by the piston. In each type of internal combustion engine, the piston is pushed downward against the crankshaft by the pressure exerted by the expansion of detonated fuel and air. Exhaust fumes are allowed to exit the cylinder when the rotation of the crankshaft and camshaft opens the exhaust valve. The movement of the piston on the subsequent oscillation creates a vacuum in the cylinder which draws additional fresh oil/fuel/air into the cylinder, thereby simultaneously pushing the remaining exhaust out the exhaust port and driving by-pass gases out of the crankcase through the positive crankcase ventilation (PCV) valve. Momentum drives the piston back into the compression stroke as the process repeats itself.

In a diesel or gasoline powered engine, as opposed to a two-stroke engine, oil lubrication of the crankshaft and connecting rod bearings is supported by an oil distribution system that is separated from the fuel/air mixture. In a diesel or gasoline powered engine, the fuel/air mixture in the intake manifold is drawn into the combustion chamber where it is ignited by either spark plugs (in a gasoline engine) or compression. The combustion chamber in both gasoline and diesel engines is largely isolated from the crankcase by a set of piston rings that are disposed around an outer diameter of each piston within each piston cylinder. The seals are included in the design of the engine as a way of containing the pressure exerted by each ignition event and forcing the exhaust gases to exit via the exhaust port rather than allowing the hot, pressurized gases to escape into the crankcase.

Unfortunately, the piston rings are unable to completely isolate and contain the pressurized exhaust gases. Consequently, small amounts of crankcase oil intended to lubricate the cylinder are instead drawn into the combustion chamber and burned during the combustion process. This is true in both gasoline and diesel powered engines. Additionally, combustion waste gases comprising unburned fuel and exhaust gases in the combustion chamber simultaneously pass the piston rings and enter the crankcase. The waste gases entering the crankcase are commonly referred to as “blow-by” or “blow-by gas”. Blow-by gases mainly consist of contaminants such as hydrocarbons (unburned fuel), carbon dioxide and/or water vapor, all of which serve to contaminate the oil held in the engine crankcase. The quantity of blow-by gases which leak into the crankcase can be several times that of the concentration of hydrocarbons in the intake manifold. Simply venting these gases to the atmosphere increases air pollution.

Alternatively, trapping the blow-by gases in the crankcase allows the contaminants to condense and accumulate over time in the engine crankcase. Condensed contaminants form corrosive acids and sludge in the interior of the components. This decreases the ability of the engine oil in the crankcase to lubricate the cylinder and crankshaft. Degraded oil that fails to properly lubricate the crankshaft components (e.g. the crankshaft and connecting rods) can contribute to accelerated wear and tear in the engine, resulting in degraded engine performance. Inadequate crankcase lubrication contributes to degradation of the piston rings, which reduces the effectiveness of the seal between the combustion chamber and the crankcase.

As the engine ages, the gaps between the piston rings and cylinder walls increase, resulting in larger quantities of blow-by gases entering the crankcase. Excessive blow-by gases in the crankcase results in power loss and eventual engine failure. Condensed water vapor carried by the blow-by gases can condense inside the engine, causing engine parts to rust. In 1970, the United States Environmental Protection Agency mandated the introduction of crankcase ventilation systems to mitigate volume of blow-by gases allowed to build up in the crankcase. In general, crankcase ventilation systems evacuate blow-by gases from the crankcase via a device referred to as a Positive Crankcase Ventilation (PCV) valve. In modern engines, blow-by gases are scavenged from the crankcase and re-routed back into the intake manifold to be re-burned.

The PCV valve re-circulates (i.e. vents) blow-by gases from the crankcase back into the intake manifold to be burned again with a fresh supply of air/fuel during subsequent combustion cycles. This is particularly desirable as the harmful blow-by gases are not simply vented to the atmosphere.

As part of an effort to combat smog in the Los Angeles basin, the State of California started requiring emission control systems on all model cars starting in the 1960s. The United States Federal Government extended these emission control regulations nationwide in 1968. Congress passed the Clear Air Act in 1970 and established the Environmental Protection Agency (EPA). Since then, vehicle manufacturers have had to meet a series of graduated emission control standards for the production and maintenance of vehicles. This involved implementing devices to control engine functions and diagnose engine problems. More specifically, automobile manufacturers started integrating electrically controlled components, such as electric fuel feeds and ignition systems. Sensors were also added to measure engine efficiency, system performance and pollution. These sensors were capable of being accessed for early diagnostic assistance.

On-Board Diagnostics (OBD) refers to early vehicle self-diagnostic systems and reporting capabilities developed and installed in automobiles by manufacturers. OBD systems provide current state information for various vehicle subsystems. The quantity of diagnostic information available via OBD has varied widely since the introduction of on-board computers to automobiles in the early 1980s. OBD originally illuminated a malfunction indicator light (MIL) for a detected problem, but did not provide information regarding the nature of the problem. Modern OBD implementations use a standardized high-speed digital communications port to provide real-time data in combination with standardized series of diagnostic trouble codes (DTCs) to facilitate rapid identification of malfunctions and the corresponding remedies from within the vehicle.

The California Air Resources Board (CARB) developed regulations to enforce the application of the first incarnation of OBD (known now as “OBD-I”). The aim of CARB was to encourage automobile manufacturers to design reliable emission control systems. CARB envisioned lowering vehicle emissions in California by denying registration to vehicles that did not pass the CARB vehicle emission standards. Unfortunately, OBD-I did not succeed at the time because the infrastructure for testing and reporting emissions-specific diagnostic information was not standardized or widely accepted. Technical difficulties in obtaining standardized and reliable emission information from all vehicles resulted in a systemic inability to effectively implement an annual emissions testing program.

OBD became more sophisticated after the initial implementation of OBD-I. OBD-II was a new standard introduced in the mid-1990s that implemented a new set of standards and practices developed by the Society of Automotive Engineers (SAE). These standards were eventually adopted by the EPA and CARB. OBD-II incorporates enhanced features that provide better engine monitoring technologies. OBD-II also monitors chassis parts, body and accessory devices, and includes an automobile diagnostic control network. OBD-II improved upon OBD-I in both capability and standardization. OBD-II specifies the type of diagnostic connector, pin configuration, electrical signaling protocols, messaging format and provides an extensible list of diagnostic trouble codes (DTCs). OBD-II also monitors a specific list of vehicle parameters and encodes performance data for each of those parameters. Thus, a single device can query the on-board computer(s) in any vehicle. This simplification of reporting diagnostic data led to the feasibility of the comprehensive emissions testing program envisioned by CARB.

The use of electrolytically-generated oxy-hydrogen gas has been known to supplement fuel combustion since the mid-18th Century. In 1766, Sir Henry Cavendish, a British scientist noted for his discovery of oxy-hydrogen or what he called “inflammable air”, described the density of inflammable air, which formed water on combustion, in a 1766 paper entitled “On Factitious Airs”. Antoine Lavoisier later reproduced Cavendish's experiment and gave the element its name (oxy-hydrogen). In 1918, Mr. Charles H. Frazer patented the first “Hydrogen Booster” system for internal combustion engines under U.S. Pat. No. 1,262,034. In his patent, Frazer stated that his invention (1) increases the efficiency of internal combustion engines, (2) completes combustion of hydrocarbons, (3) helps the engine to stay cleaner, and (4) lowers the grade of fuel that can be used with equal performance. In 1935, Henry Garrett patented an electrolytic carburetor that enabled his automobile to run on tap water. Between 1943-1945, in response to the shortage of conventional fuel, the British army used oxy-hydrogen gas generators in their tanks, boats and other vehicles to get better mileage and to prevent engine overheating for vehicles used in Africa. In 1974, Yull Brown (originally a Bulgarian Student named Ilya Velbov 1922-1998) from Australia filed a patent on his design of the ‘Brown's Gas Electrolyzer’. In 1977, scientists and engineers at the NASA Lewis Research Center conducted a series of tests using a large block American-made V8 piston engine, fully instrumented and mounted on a dynamometer. Their research was focused on determining the effects exerted by introducing oxy-hydrogen gas to the combustion cycle of a typical internal combustion engine. The results of their studies were published in NASA TN D-8478 C.1, dated May 1977, in a white paper entitled “EMISSIONS AND TOTAL ENERGY CONSUMPTION OF A MULTICYLINDER PISTON ENGINE RUNNING ON GASOLINE AND A HYDROGEN-GASOLINE MIXTURE”.

In 1983, Dr. Andrij Puharich obtained U.S. Pat. No. 4,394,230 entitled “Method and Apparatus for Splitting Water Molecules”. His apparatus was independently tested by the Massachusetts Institute of Technology and found to operate at an energy efficiency rate in excess of eighty percent. In 1990, Juan Carlos Aguero was issued European patent 0 405 919 A1 for an energy transforming system for internal combustion engines which uses Oxygen-oxy-hydrogen & steam. In 1990, Stanley A. Meyer was issued U.S. Pat. No. 4,936,961 for a method for the production of a Oxygen-Hydrogen Fuel Gas Using a Dielectric Resonant Circuit. In January 2006, TIAX published a white paper entitled “Application of Hydrogen-Assisted Lean Operation of Natural Gas-Fueled Reciprocating Engines” (HALO), a final scientific & technical report prepared under contract DE-FC26-04NT42235 with the US Department of Energy. The Abstract cites the following results—“Two key challenges facing Natural Gas Engines used for cogeneration purposes are spark plug life and high NOx emissions. Using Hydrogen Assisted Lean Operation (HALO), these two keys issues are simultaneously addressed. HALO operation, as demonstrated in this project, allows stable engine operation to be achieved at ultra-lean (relative air/fuel ratios of 2) conditions, which virtually eliminates NOx production. NOx values of 10 ppm (0.07 g/bhp-hr NO) for 8% (LHV H2/LHV CH4) supplementation at an exhaust 02 level of 10% were demonstrated, which is a 98% NOx emissions reduction compared to the leanest unsupplemented operating condition. Spark ignition energy reduction (which will increase ignition system life) was carried out at an oxygen level of 9%, leading to a NOx emission level of 28 ppm (0.13 g/bhp-hr NO). The spark ignition energy reduction testing found that spark energy could be reduced 22% (from 151 mJ supplied to the coil) with 13% (LHV H2/LHV CH4) oxy-hydrogen supplementation, and even further reduced 27% with 17% oxy-hydrogen supplementation, with no reportable effect on NOx emissions for these conditions and with stable engine torque output. Another important result is that the combustion duration was shown to be only a function of oxy-hydrogen supplementation, not a function of ignition energy (until the ignitability limit was reached). The next logical step leading from these promising results is to see how much the spark energy reduction translates into increase in spark plug life, which may be accomplished by durability testing.” In 2006, 2006/0075683 A1 was published for “Apparatus and method for the conversion of water into a new gaseous and combustible form and the combustible gas formed thereby.” In 2007, under contract number NAS7-100, the Jet Propulsion Laboratory at Pasadena, Calif., issued a white paper entitled “Feasibility Demonstration of a Road Vehicle Fueled with Hydrogen-enriched Gasoline”. Their research demonstrated that the addition of stoichiometric mixtures of oxy-hydrogen gas to gasoline combusted in a conventional internal combustion engine“ . . . reduced NOx emissions and improved thermal efficiency.”

However, these systems have several existing problems. One of the approaches involves generating oxy-hydrogen on a continual basis and storing the oxy-hydrogen for extraction when needed. However, electrically charging the generator plates requires too much of a standard alternator, thus a higher performance alternator is required. Also, consumers have been afraid of existing oxy-hydrogen systems due to the fact these systems constantly produce oxy-hydrogen and store it. This potentially could create explosion concerns due to the stored oxy-hydrogen sitting in the automobile

Several problems inhibit the effectiveness of adding oxy-hydrogen gas to supplement fuel combustion in conventional ICE's. None of the patented or commercially available oxy-hydrogen generators are computer controlled in a way that is compatible with OBD-II and OBD-III ECM systems. Further, existing oxy-hydrogen generators designed for use in automobiles generate substantial quantities of water vapor, which is intrinsically inimical to the ferrous components which comprise modern engines.

These problems are addressed in U.S. Pat. No. 9,051,872 which issued Jun. 9, 2015 to the present applicant. That patent discloses an oxy-hydrogen generator which is incorporated into a standard internal combustion engine. A microcontroller activates the oxy-hydrogen generator when oxy-hydrogen is needed. The oxy-hydrogen is then mixed with blow-by gases from a PCV valve, which are recycled through the intake manifold. In this patent the on-demand oxy-hydrogen generator comprised a fluid reservoir containing an electrolyte solution.

There remains, however, the need for improved oxy-hydrogen gas generator systems which supply computer-controlled stoichiometric volumes of gas on-demand, do not require generation and storage of oxy-hydrogen gas for later use, are compatible with the operating parameters intrinsic to electronically controlled engine management modules, and do not generate a significant quantity of water vapor. The present invention fulfills these needs, and provides other related advantages.

### SUMMARY OF THE INVENTION

The present invention is directed to an on-demand oxy-hydrogen generator for use in internal combustion engines. The on-demand oxy-hydrogen generator comprises, generally, (a) a fluid reservoir containing electrically conductive de-gassed water; (b) a cap for sealing an opening on the fluid reservoir, wherein the cap has a positive terminal, a negative terminal and a gas outlet in communication with an interior of the fluid reservoir; and (c) a pair of the electrode plates attached to the cap and extending into the interior of the fluid reservoir so as to be at least partially submerged in the de-gassed water, one of the pair of electrode plates electrically coupled to the positive terminal and another of the pair of electrode plates electrically coupled to the negative terminal.

Positively charged nano-particles of silver and/or platinum may be suspended within the de-gassed water. The positively charged nano-particles comprise a catalyst in an electrolysis reaction of the de-gassed water.

A sensor is provided for detecting quantitative suspension parameters of the positively charged nano-particles within the de-gassed water.

The electrode plates may comprise non-metallic conductive coatings such as a field of carbon nano-tubes. Alternatively, the electrode plates may comprise a series of metal plates made from a metal selected from the group consisting of zinc, cadmium, gold, platinum and palladium, or from beryllium-copper, beryllium-titanium, and sodium-tungsten alloys. The metal plates also comprise a catalyst in an electrolysis reaction of water.

A secondary reservoir is provided which contains additional de-gassed water. The secondary reservoir is fluidly connected to the fluid reservoir. A sensor is also provided which for detecting the level of the de-gassed water in the fluid reservoir.

A gas outlet on the oxy-hydrogen generator releases oxy-hydrogen produced by electrolysis of the de-gassed water. The gas outlet is fluidly coupled to an intake manifold on the engine. Further, a microcontroller is operably connected to the oxy-hydrogen generator for selectively activating the oxy-hydrogen generator in response to a demand for oxy-hydrogen (HOH). The gas outlet is fluidly coupled to a pollution control system for recycling blow-by gases from a crankcase on the internal combustion engine to the intake manifold.

The pollution control system comprises a PCV (Positive Crankcase Ventilation) valve in-line with a vent line from the crankcase and a blow-by return line to the intake manifold. The gas outlet is coupled to the vent line from the crankcase, the blow-by return line to the intake manifold, or the PCV valve.

The microcontroller is operably connected to the PCV valve for regulating a flow rate of blow-by gases through the PCV valve.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a schematic diagram of an automobile, illustrating various sensors as well as a microcontroller and a PCV valve and an on-demand oxy-hydrogen generator operably coupled to the PCV valve and microcontroller, in accordance with the present invention;

FIG. 2 is a diagrammatic cross-sectional view of an internal combustion engine illustrating the incorporation of the oxy-hydrogen generator of the present invention;

FIG. 3 is a perspective view of a cap and electrode plates of the oxy-hydrogen generator of the present invention; and

FIG. 4 is a perspective view of an oxy-hydrogen generator embodying the present invention generating oxy-hydrogen, and coupled to an optional bubbler reservoir.

### DETAILED DESCRIPTION OF THE PREFERRED EMBODIMENTS

As shown in the drawings, for purposes of illustration, the present invention is directed to an on-demand oxy-hydrogen fuel system which is incorporated into a standard internal combustion engine. The oxy-hydrogen generator embodying the present invention is referred to generally by the reference number 100. In a particularly preferred embodiment, the oxy-hydrogen generator 100 of the present invention is incorporated into a pollution control system, such as that illustrated and described in U.S. Pat. No. 8,360,038 and US2014/0207360 A1, the contents of which are incorporated herein by reference. As such, the oxy-hydrogen generated by the system of the present invention is added to blow-by gases regulated by a microcontroller 10 and a PCV valve 12.

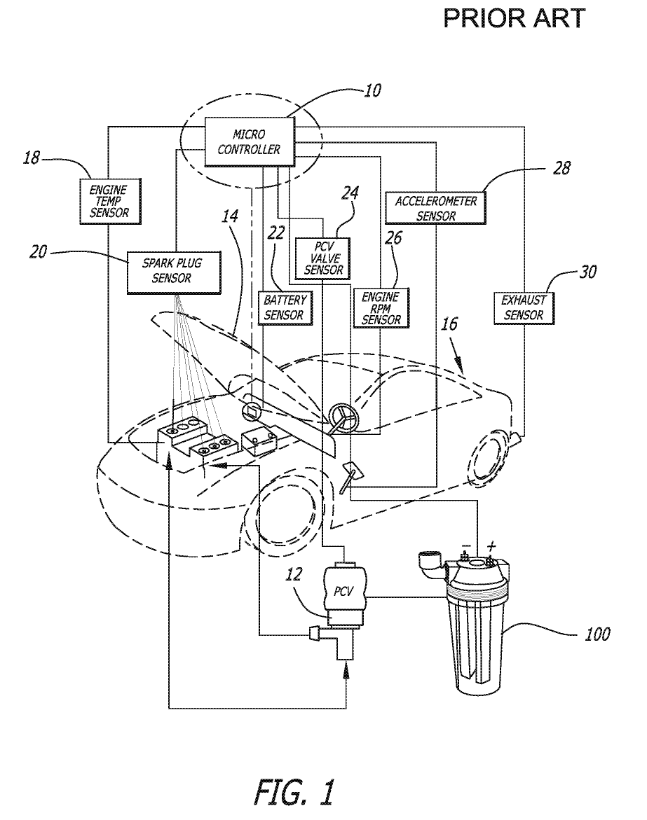

In FIG. 1, the microcontroller 10 is preferably mounted under a hood 14 of an automobile 16. The microcontroller 10 is electrically coupled to one or more of a plurality of sensors that monitor and measure real-time operating conditions and performance of the automobile 16. The microcontroller 10 regulates the flow rate of blow-by gases by regulating the engine vacuum in a combustion engine through digital control of a PCV valve 12. The microcontroller 10 receives real-time input from sensors that might include an engine temperature sensor 18, a spark plug sensor 20, a battery sensor 22, a PCV valve sensor 24, and engine RPM sensor 26, an accelerometer sensor 28, and an exhaust sensor 30. Data obtained from the sensors 18, 20, 22, 24, 26, 28, and 30 by the microcontroller 10 is used to regulate the PCV valve 12, as described in more detail below. The microcontroller 10 preferably comprises a digitally controlled back-flash diode and a digitally controlled pressure regulator valve rather than just an on-off regulator designed to meet HOH demand.

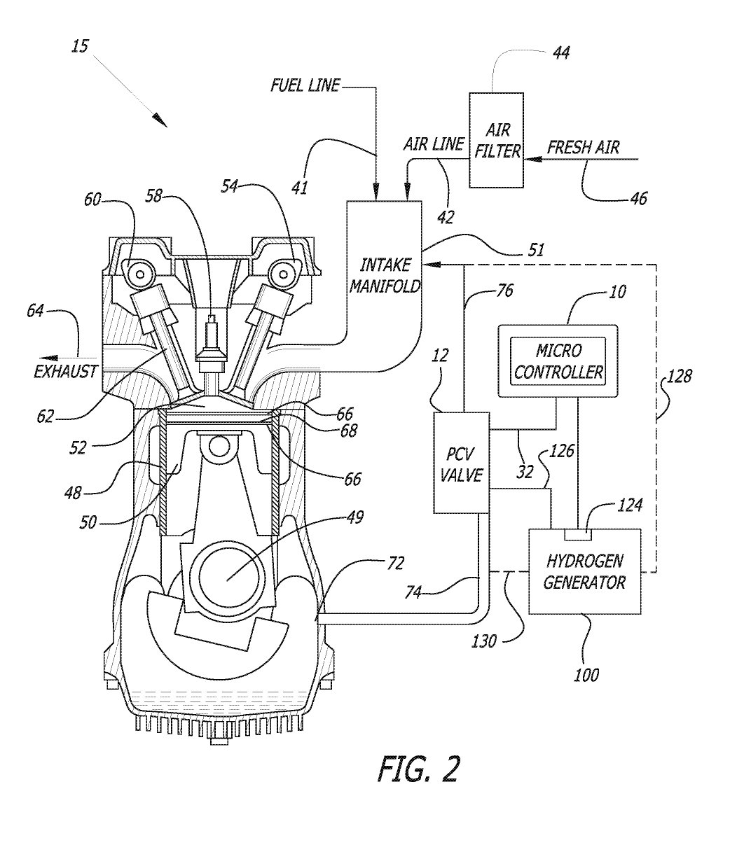

FIG. 2 is a schematic illustrating operation of the microcontroller 10 in conjunction with the PCV valve 12 in a car engine 15. As shown in FIG. 2, the PCV valve 12 is disposed between a crankcase 49, of an engine 15, and an intake manifold 51. In operation, the intake manifold 51 receives a mixture of fuel and air via a fuel line 41 and an air line 42, respectively. An air filter 44 may be disposed between the air line 42 and an air intake line 46 to filter fresh air before mixing with fuel in the intake manifold 51. The air/fuel mixture in the intake manifold 51 is delivered to a piston cylinder 48 as a piston 50 descends downward within the cylinder 48 from the top dead center. This creates a vacuum within a combustion chamber 52. Accordingly, an input camshaft 54 rotating at half the speed of the crankshaft 49 is designed to open an input valve 56 thereby subjecting the intake manifold 51 to the engine vacuum. Thus, fuel/air is drawn into the combustion chamber 52 from the intake manifold 51.

The fuel/air in the combustion chamber 52 is ignited by a spark plug 58 (in a gasoline engine). The rapid expansion of the ignited fuel/air in the combustion chamber 52 causes depression of the piston 50 within the cylinder 48. After combustion, an exhaust camshaft 60 opens an exhaust valve 62 to allow escape of the combustion gases from the combustion chamber 52 out an exhaust line 64. Typically, during the combustion cycle, excess exhaust gases slip by a pair of piston rings 66 mounted in the head 68 of the piston 50. These “blow-by gases” enter the crankcase 49 as high pressure and temperature gases. Over time, harmful exhaust gases such as hydrocarbons, carbon monoxide, nitrous oxide and carbon dioxide can condense out from a gaseous state and coat the interior of the crankcase 49 and mix with the oil 70 that lubricates the mechanics within the crankcase 49.

But, the PCV valve 12 is designed to vent these blow-by gases from the crankcase 49 to the intake manifold 51 to be recycled as fuel for the engine 15. This is accomplished by using the pressure differential between the crankcase 49 and the intake manifold 51. In operation, the blow-by gases exit the relatively higher pressure crankcase 49 through a vent 72 and travel through a vent line 74, the PCV valve 12, a blow-by return line 76 and into a relatively lower pressure intake manifold 51 coupled thereto. Accordingly, the quantity of blow-by gases vented from the crankcase 49 to the intake manifold 51 via the PCV valve 12 is digitally regulated by the microcontroller 10, which is connected to the PCV valve via connection wires 32. The microcontroller 10 is powered by a battery 11 and grounded at the ground connection 13.

In particular, venting blow-by gases based on engine speed and other operating characteristics of an automobile decreases the quantity of hydrocarbons, carbon monoxide, nitrogen oxide and carbon dioxide emissions. The PCV valve 12 and microcontroller 10 recycle gases by burning them in the combustion cycle. No longer are large quantities of the contaminants expelled from the vehicle via the exhaust. Hence, when installed in an automobile engine, the PCV valve 12 and microcontroller 10 are capable of reducing air pollution emissions for each automobile, increasing gas mileage per gallon, increasing horsepower performance, reducing engine wear (due to low carbon retention) and dramatically reducing the number of oil changes required.

In operation, the microcontroller 10 functions in three states. First, upon ignition of the vehicle, the microcontroller 10 causes the solenoid 80 in the PCV valve 12 to stay closed, as described above. This is because the engine 15 of the vehicle produces large quantities of pollution while still heating up. Once the engine 15 is properly heated, it functions more efficiently and produces less pollution. At that point, the microcontroller 10 enters the next state and functions as a window switch based on the engine RPM. While the engine is operating with a certain RPM range, the microcontroller 10 causes the solenoid 80 in the PCV valve 12 to open. Once the engine falls out of that RPM range, the solenoid 80 in the PCV valve 12 closes again. If the vehicle is being driven in conditions where the RPM stays in the given range for long periods of time (i.e. highway driving), then the microcontroller 10 activates a timing sequence so the vehicle's on-board diagnostics is prevented from introducing too much fuel into the engine. This timing sequence can be programmed to any interval, but in the preferred embodiment the sequence causes the solenoid 80 in the PCV valve 12 to be open for two minutes, then closed for 10 minutes. This sequence is repeated indefinitely until the engine RPM falls out of the given range.

While the logic of the microcontroller 10 is based primarily on engine RPM, the microcontroller 10 may have logic based on other criteria. Such criteria may be engine temperature and engine torque, as well as crankcase pressure. Basing the microcontroller logic on these additional criteria makes for a control system that is more adjustable and programmable.

With reference to FIGS. 1 and 2, the oxy-hydrogen generator 100 of the present invention is operably coupled to the microcontroller 10 and the PCV valve 12. The microcontroller 10 is used to selectively power the oxy-hydrogen generator 100, causing the oxy-hydrogen generator 100 to generate oxy-hydrogen and create a flow of oxy-hydrogen into the PCV valve and/or the intake manifold 51 with the blow-by gases from the crankcase. The produced oxy-hydrogen is approximately 180 octane, and thus provides a very efficient fuel source that can dramatically increase fuel efficiency and reduce emissions.

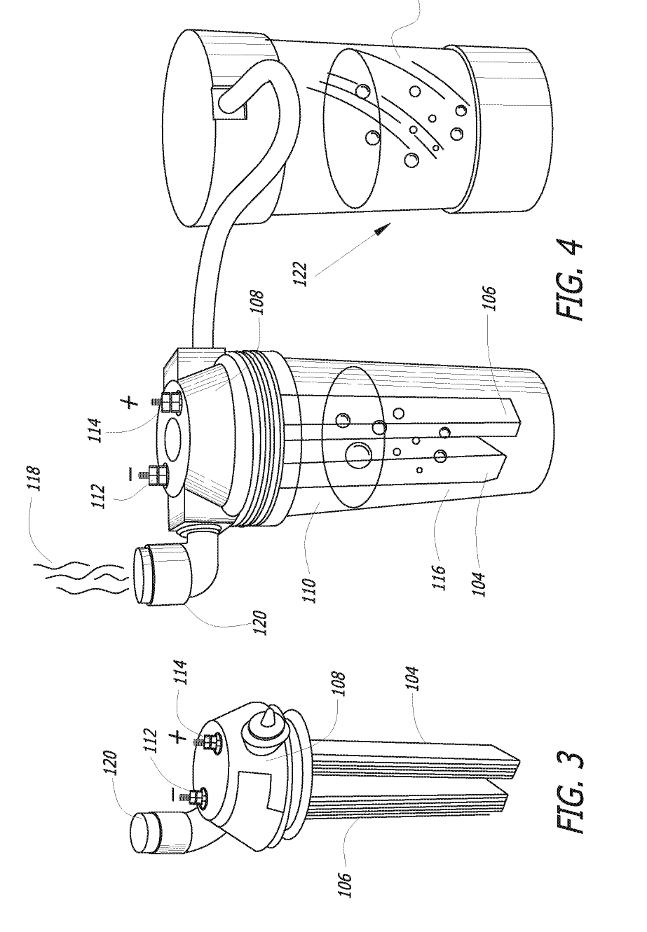

With reference now to FIG. 3, the oxy-hydrogen generator 100 comprises a series of electrode plates 104 and 106, comprising anode and cathode electrodes. The plates 104 and 106 can comprise any known conductors which can be used for electrolysis of a water solution into oxy-hydrogen gas. The plates 104 and 106 may serve as a catalyst or promoter to facilitate the rate of the chemical reaction of the water being turned into oxy-hydrogen gas and oxygen. Alternatively, the plates merely serve to conduct electricity through the water solution to perform the electrolysis and electrically convert the water molecules to oxy-hydrogen and oxygen gas.

The plates 104 and 106 may be metallic plates comprising zinc, gold, platinum, cadmium, palladium and the like. Such plates, however, typically cannot be used long term without substantial degradation, especially in anode applications. Alternative alloyed elements such as beryllium-copper, beryllium-titanium, and/or sodium-tungsten are significantly superior in terms of (a) conductivity, (b) surface degradation, (c) residual persistence, and (d) longevity. Further, when the anode/cathode metals are carefully matched to optimize electron exchange (e.g., sodium-tungsten anodes with beryllium-copper cathodes), the dissociation efficiency of an electrolytic cell can be substantially increased.

The principle challenges associated with the water electrolysis process are related to the form, structure and allowable effective surface area provided by anode and cathode elements. In conventional HHO generators, 316 stainless steel plates are placed in close proximity to each other with gaps between them designed to allow electrolytic solutions to flow freely. The surface of the plates is ‘scruffed’ using a rough grinding disk to increase the effective surface area exposed to the electrical interactions that occur between the ionic salts held in solution and the ragged ‘points’ characterized by roughening the surface of the plates. The reaction between the solution and the electrical discharge occurring at the surface of the plates is optimized at the microscopic tips or points created by scruffing the plate surfaces. SEM microscopy illustrates the liberation of H+ and OH− ions occurring at those points.
The fundamental limitation of this approach is that no amount of surface treatment can be expected to significantly increase the effective surface area exhibited by a flat plate. However, two approaches have been demonstrated that mitigate this limitation:
Metallic Foam—the use of finely divided open-cell metallic foam panels exponentially increases the amount of HOH gas that can be generated as compared with flat panels of conductive metals (e.g., 316 Stainless Steel, Copper, etc.); and
Carbon nano-tubes—Carbon nano-tube structures can be grown in situ on the surface of electrically conductive substrates with extraordinary precision and at rapidly declining costs. Carbon nano-tube technologies serve to (a) exponentially increase surface area, and (b) exponentially increase ionization/dissociation efficiencies in electrolytical processes.

Accordingly, optimal effectiveness and energy efficiency in an electrolytic apparatus can best be achieved when the combination of anode-cathode materials, solution conductivity, exposed surface area and optimal geometry can be integrated in an array that effectively liberates transitional hydrogen (protium) and hydroxyl ions from aqueous suspensions rather than attempting to break the H—OH bonds as described in conventional literature.

Accordingly, the present invention contemplates the use of the electrically-conductive materials for anode and/or cathode conductors that are not metallic. For example, conductive substrates coated with a field of carbon nano-tubes grown in place with a specified number of “turns” or “twists” will provide much higher conductivity and exponentially-increased surface area when compared with flat metallic plates.

With reference to FIGS. 3 and 4, the oxy-hydrogen generator 100 includes a cap 108 which seals the top of a container 110. Electrodes or terminals 112 and 114, representing the cathode and anode, extend from electrical coupling to the plates 104 and 106 to the exterior of the cap 108 so as to be coupled to electrical wires from the electrical source of the internal combustion engine, such as the battery, alternator or the like.

Pure water is not a very effective conductor, and it would require that a large amount of electricity to be applied to the electrodes 112 and 114 in order to electrolyze the water into oxy-hydrogen. Thus, in one preferred form of the invention, an electrolyte water solution is created, such as by adding an electrolytic salt—potassium nitrate, sodium bicarbonate (baking soda) or the like—to the water. This creates an effective electrolyte solution which requires much less electricity to cause the electrolysis of the water. As the plates 104 and 106 become electrically charged, they cause the electrolyte solution 116 to boil, creating oxy-hydrogen gas 118 in an upper portion of the oxy-hydrogen generator 100. This oxy-hydrogen gas 118 is channeled via outlet 120 to the intake manifold 51, either by means of the PCV valve 12 and/or introducing the oxy-hydrogen gas directly into the intake manifold 51 or plumbing the system such that it is combined with the blow-by gases from the crankcase before they enter the intake manifold 51. As mentioned above, the produced oxy-hydrogen is approximately 180 octane, and thus provides a very efficient fuel source for re-burning the blow-by gases so as to dramatically increase fuel efficiency and reduce emissions.

An alternative to using an electrolytic salt in solution in water as a way of increasing the electrical conductivity of water is through the use of ultra-pure de-gassed water as disclosed in US2005/0096398, the contents of which are incorporated herein by reference. This process for the production of emulsions and dispersions provides a means for radically altering the electrical structure of water that does not require the addition of an electrolytic salt.

Another alternative to using an electrolytic salt in solution in water as a way of increasing the electrical conductivity of water is through the use of laser-generated spherical, positively charged nano-particles of silver and/or platinum held in suspension as a way of reducing the dissociation voltage of water into H+ and OH− radicals from 1.43 VDC to 0.89 VDC without the need to add electrolytic salts. See, for example, US2013/0001833, the contents of which are incorporated herein by reference.

By way of background information and explanation, the current/standard model approaches the issue of dissociation in terms of the ideal gas model. In this model, the water molecule is viewed in terms of individual molecules operating as mutually exclusive constituents rather than in terms of the dynamical relationships which actually occur at sub-molecular scales.

The ideal gas formula dictates that 1 mole of H₂O (18 grams) can be expected to generate 22.1 liters of HOH gas at 70° F. at sea level using a dissociation voltage of 1.23 VDC at varying levels of amperage. The experimental data collected over the past 150 years demonstrates that the formula is in error by as much as 16.2% in actual practice. Science has struggled unsuccessfully to explain the discrepancy between the theoretical versus actual results obtained when water is dissociated using a wide variety of techniques under carefully controlled conditions. The actual dissociation voltage threshold that has been repeatedly demonstrated is 1.43-1.48 VDC. The energy density predicted by the ideal gas formula equates for HOH gas relative to gasoline (for example) is 22.4 liters of HOH=1 ml 87 octane gasoline (no ethanol).

Laboratory tests have repeatedly demonstrated significant variances between actual practice and the results predicted by the ideal gas law. For example, when 18 meg-ohm water is thoroughly degassed (using conventional, off-the-shelf apparatus currently in general use in most hospitals in the USA), HOH can be produced at the rate of 22.4 liters per mole at an effective voltage of 0.122 VDC—fully 10 times more efficiently than the predicted rate. Further, the energy density of HOH gas (depending on meteorological variables such humidity, temperature, dew point, etc.) is 1.8-2.4 liters HOH=1 ml 87 octane gasoline, which is also fully 10 times greater than the predicted value generated with the ideal gas formula.

When 0.69 nano-meter spherical, positively charged particles of silver (generated by the Attostat method) are suspended in 10 meg-ohm water, the threshold for dissociation drops from 1.43 VDC to 0.89 VDC, all other variables being equal. When the same particles are introduced to degassed 18 meg-ohm water, the dissociation voltage drops to 0.122 VDC.

These results are explained by the description of molecular interactions occurring in water introduced by the Y-Bias and Angularity model of fine scale physical interactions. In summary, the Y-Bias model shows that:
Water molecules exchange H+ ions with neighboring water molecules at the rate of 10¹⁷ per molecule per second. The net effect of this insight is that at any given moment in time, at least 50% of the H+ ions which comprise water are unbounded and in transition;
The Infinite Rydberg Limit (energy density) of bounded hydrogen atoms in water molecules is calculated in terms of temperature and others meteorological factors. It is taken as defacto that the values determined by this method are directly calculable as sub-sets of the ideal gas law formulations. But there is a fundamental problem with this approach —when at least 50% of the H+ ions are in transition (and unbounded), there is no mathematical expression extant that describes the Rydberg Limits of transitional Hydrogen ions that do not carry an electron with them. The net differential between the theoretical input energy required to dissociate HOH into H+ and OH− is therefore a function of an underlying dynamic that is ignored by the conventional model; and
Water cannot exist in liquid form without the introduction of extrinsic foreign ‘contaminants’ in the form of colloids, molecules, particles, or gases of other materials. The demonstration of how powerfully this effects the behavioral dynamics of water is described in US 2005/0096398 A1. When water is purified—that is, when the foreign particulates are removed—and degassed, it becomes exceptionally conductive and unstable. In this state, degassed water can be sprayed on the sides of petroleum storage tanks (for example) to immediately remove caked deposits by taking them fully into solution. In this circumstance, oil and water become fully miscible. This is demonstrates why degassed water can be dissociated at very low voltage and current.

A careful review of US2013/0001833 yields some important insights into the role of catalytic processes that operate at the sub-molecular level in water. Ordinarily, silver held in suspension in water as a colloidal dispersion will precipitate voluntarily over time. This is a function of (a) variation in size, (b) variations in geometry, and (c) ambient negative charge held by the particles as a product of the generation process. The process of US2013/0001833 is much different in both form and function. It produces nano-particles that are (a) absolutely uniform, (b) absolutely spherical, and (c) positively and uniformly charged before being introduced as a suspension product. Silver particles manufactured by this process do not precipitate out of suspension voluntarily. Suspensions have been held in storage for more than 5 years without demonstrating any significant degree of precipitation. The fact that the silver nano-particles held in suspension are positively charged enables them to act as electrical charge-discharge step-stones between water molecules without dissociating the water molecules in the same manner as ionic salts.

Several salutary benefits are produced by the use of this material in an electrolysis process: (a) a single charge of silver or platinum nano-spheres introduced as a suspension to distilled water does not need to be replaced once the suspension has been created (as long as the reservoir is not allowed to be completely depleted); (b) the use of such particles does not introduce a contaminating stream of pollutants to the environment as a waste product; and (c) the use of such particles increases the net efficiency of the electrolysis process by one order of magnitude.

As illustrated in FIG. 4, the system of the present invention may incorporate a reservoir bubbler 122 having additional electrolyte solution 116 therein so as to refill and recharge the oxy-hydrogen generator 100 as the electrolyte solution levels decrease over time as gases are produced. However, the reservoir bubbler 122 does take up valuable space within the engine compartment. Thus, it is contemplated that the present invention includes a sensor 124 in the oxy-hydrogen generator 100 which will alert the user when the water electrolyte solution level gets low. It is anticipated with normal use, the electrolyte water solution will only need to be filled every few months.

It will be appreciated by those skilled in the art that the present invention overcomes many of the concerns and disadvantages of existing and proposed automobile oxy-hydrogen systems. The system is “on-demand”, and thus only generates oxy-hydrogen when it is needed. This is digitally controlled via the microcontroller 10, and thus there is no excess oxy-hydrogen that needs to be stored, which can create fire and explosion concerns or require safety precautions for safely storing the extra oxy-hydrogen, as with existing oxy-hydrogen generation systems.

The system of the present invention avoids issues relating to the automobile's fuel sensor. Fuel sensors are not calibrated to account for such a rich fuel source. However, bringing the oxy-hydrogen generated by the system of the present invention through a “back door” by mixing it with the blow-by effectively circumvents the automobile's fuel sensor.

Whereas existing oxy-hydrogen generator systems for automobiles are problematic as the oxy-hydrogen is generated with a large amount of water vapor, which gets into the engine and eventually causes rust, the present invention eliminates this concern as the PCV valve continually vents vapor out of the crankcase. Thus, the water vapor generated with the oxy-hydrogen is not in the crankcase or engine long enough to cause any serious rust concerns.

Although several embodiments have been described in detail for purposes of illustration, various modifications may be made without departing from the scope and spirit of the invention. Accordingly, the invention is not to be limited, except as by the appended claims.

What is claimed is:

1. An on-demand oxy-hydrogen generator for an internal combustion engine, comprising:
a fluid reservoir containing electrically conductive de-gassed water;
a cap for sealing an opening on the fluid reservoir, wherein the cap has a positive terminal, a negative terminal and a gas outlet in fluid communication with an interior of the fluid reservoir; and
a pair of electrode plates attached to the cap and extending into the interior of the fluid reservoir so as to be at least partially submerged in the de-gassed water, one of the pair of electrode plates electrically coupled to the positive terminal and another of the pair of electrode plates electrically coupled to the negative terminal.

2. The on-demand oxy-hydrogen generator of claim 1 wherein the electrode plates comprise non-metallic conductive coatings.

3. The on-demand oxy-hydrogen generator of claim 2, wherein the nonmetallic conductive coating comprises carbon nano-tubes.

4. The on-demand oxy-hydrogen generator of claim 1, wherein the electrode plates comprises a series of metal plates made from a metal selected from the group consisting of zinc, cadmium, gold, platinum, and palladium, or from beryllium-copper, beryllium-titanium and/or sodium-tungsten alloys.

5. The on-demand oxy-hydrogen generator of claim 4, wherein the series of metal plates comprise a catalyst in an electrolysis reaction of water.

6. The on-demand oxy-hydrogen generator of claim 1, further comprising a secondary reservoir containing additional de-gassed water, the secondary reservoir fluidly connected to the fluid reservoir.

7. The on-demand oxy-hydrogen generator of claim 1, further comprising a sensor configured to detect a level of the de-gassed water in the fluid reservoir.

8. The on-demand oxy-hydrogen generator of claim 1,
wherein a gas outlet on the oxy-hydrogen generator releases oxy-hydrogen produced by electrolysis of the de-gassed water, the gas outlet fluidly coupled to an intake manifold on the engine, and further comprising:
a microcontroller operably connected to the oxy-hydrogen generator for selectively activating the oxy-hydrogen generator in response to a demand for oxy-hydrogen.

9. The on-demand oxy-hydrogen generator of claim 8, wherein the gas outlet is fluidly coupled to a pollution control system for recycling blow-by gases from a crankcase on the internal combustion engine to the intake manifold.

10. The on-demand oxy-hydrogen generator of claim 9, wherein the pollution control system comprises a PCV valve in-line with a vent line from the crankcase and a blow-by return line to the intake manifold.

11. The on-demand oxy-hydrogen generator of claim 10, wherein the gas outlet is coupled to the vent line from the crankcase, the blow-by return line to the intake manifold, or the PCV valve.

12. The on-demand oxy-hydrogen generator of claim 10, wherein the microcontroller is operably connected to the PCV valve.

13. An on-demand oxy-hydrogen generator for an internal combustion engine, comprising:
a fluid reservoir containing electrically conductive de-gassed water;
a cap for sealing an opening on the fluid reservoir, wherein the cap has a positive terminal, a negative terminal and a gas outlet in fluid communication with an interior of the fluid reservoir;
a pair of electrode plates attached to the cap and extending into the interior of the fluid reservoir so as to be at least partially submerged in the de-gassed water, one of the pair of electrode plates electrically coupled to the positive terminal and another of the pair of electrode plates electrically coupled to the negative terminal; and
positively charged nano-particles of silver and/or platinum suspended within the de-gassed water.

14. The on-demand oxy-hydrogen generator of claim 13, wherein the positively charged nano-particles comprise a catalyst in an electrolysis reaction of the de-gassed water.

15. The on-demand oxy-hydrogen generator of claim 13, further comprising a sensor for detecting quantitative suspension parameters of the positively charged nano-particles within the de-gassed water.

16. The on-demand oxy-hydrogen generator of claim 13 wherein the electrode plates comprise non-metallic conductive coatings.

17. The on-demand oxy-hydrogen generator of claim 16, wherein the nonmetallic conductive coating comprises a carbon nano-tube field.

18. The on-demand oxy-hydrogen generator of claim 13, further comprising a secondary reservoir containing additional de-gassed water, the secondary reservoir fluidly connected to the fluid reservoir.

19. The on-demand oxy-hydrogen generator of claim 13, further comprising a sensor configured to detect a level of the de-gassed water in the fluid reservoir.

20. The on-demand oxy-hydrogen generator of claim 13
wherein a gas outlet on the oxy-hydrogen generator releases oxy-hydrogen produced by electrolysis of the de-gassed water, the gas outlet fluidly coupled to an intake manifold on the engine; and further comprising:
a microcontroller operably connected to the oxy-hydrogen generator for selectively activating the oxy-hydrogen generator in response to a demand for oxy-hydrogen.

21. The on-demand oxy-hydrogen generator of claim 14, wherein the gas outlet is fluidly coupled to a pollution control system for recycling blow-by gases from a crankcase on the internal combustion engine to the intake manifold.

22. The on-demand oxy-hydrogen generator of claim 20, wherein the pollution control system comprises a PCV valve in-line with a vent line from the crankcase and a blow-by return line to the intake manifold.

23. The on-demand oxy-hydrogen generator of claim 22, wherein the gas outlet is coupled to the vent line from the crankcase, the blow-by return line to the intake manifold, or the PCV valve.

24. The on-demand oxy-hydrogen generator of claim 22, wherein the microcontroller is operably connected to the PCV valve for regulating a flow rate of blow-by gases through the PCV valve.
